(19) United States
(12) Patent Application Publication
(10) Pub. No.: US 2013/0159214 A1
(43) Pub. Date: Jun. 20, 2013

(54) VEHICULAR GEOSPATIAL DATA BASED MEASUREMENT OF RISK ASSOCIATED WITH A SECURITY INTEREST IN A LOAN/LEASE PORTFOLIO

(71) Applicants: Brian Boling, Knoxville, TN (US); Tom Beerle, Burlingame, CA (US); Curtis Schantz, Schottsdale, AZ (US)

(72) Inventors: Brian Boling, Knoxville, TN (US); Tom Beerle, Burlingame, CA (US); Curtis Schantz, Schottsdale, AZ (US)

(21) Appl. No.: 13/710,954

(22) Filed: Dec. 11, 2012

Related U.S. Application Data
(63) Continuation of application No. 13/328,070, filed on Dec. 16, 2011.

(51) Int. Cl. G06Q 40/06

(52) U.S. Cl. CPC G06Q 40/06
USPC 705/36 R

(57) ABSTRACT

A method includes receiving, at a tracking server, geospatial location data of a vehicle at various points in time from a transmitter installed therein. The vehicle is associated with a borrower in a loan agreement or a lease agreement with a lending institution with regard to an asset. The method also includes determining a location of the vehicle and a pattern of usage thereof based on the geospatial location data received, permitting a financial entity server associated with the lending institution access to the location of the vehicle and the pattern of usage thereof, and determining an event based on the location of the vehicle and the pattern of usage thereof. Further, the method includes generating, through the tracking server, a risk score associated with a security interest in the asset and/or a loan/lease portfolio related to the asset based on a risk scoring methodology implemented therein.

### CLAIM OF PRIORITY

This application is a Continuation (CON) of and incorporates by references in its entirety, U.S. patent application Ser. No. 13/328,070, titled “GEOSPATIAL DATA BASED MEASUREMENT OF RISK ASSOCIATED WITH A VEHICULAR SECURITY INTEREST IN A VEHICULAR LOAN PORTFOLIO” and filed on Dec. 16, 2011.

### FIELD OF TECHNOLOGY

This disclosure relates generally to vehicular tracking and, more particularly, to a method, an apparatus and/or a system of vehicular geospatial data based measurement of risk associated with a security interest in a loan/lease portfolio.

### BACKGROUND

A party interested in acquiring a security interest on a borrowed asset such as a vehicle, a home, an electronic item (e.g., television) or a loan portfolio may be interested in assessing the financial value of the security interest or the loan portfolio prior to executing a transaction with a seller. Determining the financial value and the financial risk associated with the security interest or the loan portfolio may require personal data associated with a borrower. For example, access to location data of a vehicle of the borrower at a point in time or across multiple points in time may enable identification of high risk behavior on part of the borrower through providing interested parties and/or buyers an understanding of the borrower's driving patterns. Certain locations, driving behaviors and/or patterns of movement associated with the borrower and his/her vehicle may be indicative of an increased or decreased financial risk and a corresponding financial value associated with the security interest.

In the case of vehicles such as automobiles, financing may be through Original Equipment Manufacturer (OEM) captive lenders and third party lending institutions such as banks, credit unions, specialty finance companies or automobile dealers. The borrower or purchaser of the vehicle may borrow money from the lending institution, following which he/she makes monthly payments on the loan to the lending institution. Typically, the title of the vehicle may remain with the lending institution until the loan amount has been paid in full. However, the lending institution may want to sell the security interest in the vehicle to another party or may want to bundle several vehicles into a vehicular loan portfolio and sell that loan portfolio. The lack of methodologies to measure financial risk may render it difficult to assess the abovementioned financial value of the security interest or the loan portfolio.

### SUMMARY

Disclosed are a method, an apparatus and/or a system of vehicular geospatial data based measurement of risk associated with a security interest in a loan/lease portfolio.

In one aspect, a method includes receiving, at a tracking server, geospatial location data of a vehicle at various points in time from a transmitter installed in the vehicle. The vehicle is associated with a borrower in a loan agreement or a lease agreement with a lending institution with regard to an asset. The lending institution is a party having a security interest in the asset and/or a party interested in acquiring the security interest in the asset and/or a loan or a lease portfolio related to the asset. The method also includes determining, through a processor of the tracking server, a location of the vehicle and a pattern of usage thereof based on the geospatial location data received, permitting a financial entity server associated with the lending institution access to the location of the vehicle and the pattern of usage thereof through the tracking server, and determining an event through the processor of the tracking server based on the location of the vehicle and the pattern of usage thereof.

Further, the method includes generating, through the processor of the tracking server, a risk score associated with the security interest in the asset and/or the loan or the lease portfolio related to the asset based on a risk scoring methodology implemented therein. The risk scoring methodology utilizes the event determination.

In another aspect, a method includes acquiring, through a data collection device including a processor communicatively coupled to a memory, geospatial location data of a vehicle at various points in time. The vehicle is associated with a borrower in a loan agreement or a lease agreement with a lending institution with regard to an asset. The lending institution is a party having a security interest in the asset and/or a party interested in acquiring security interest in the asset and/or a loan or a lease portfolio related to the asset. The method also includes determining, through the processor, a location of the vehicle and a pattern of usage thereof based on the geospatial location data acquired, determining an event through the processor based on the location of the vehicle and the pattern of usage thereof, and generating, through the processor, a risk score associated with the security interest in the asset and/or the loan or the lease portfolio related to the asset based on a risk scoring methodology implemented therein. The risk scoring methodology utilizes the event determination.

Further, the method includes transmitting the location data of the vehicle, the pattern of usage thereof and/or the generated risk score to a collection server, and enabling, through the collection server, access to the transmitted location data of the vehicle, the pattern of usage thereof and/or the generated risk score by a financial entity server associated with the lending institution.

In yet another aspect, a system includes a vehicle including a transmitter installed therein to transmit geospatial location thereof at various points in time. The vehicle is associated with a borrower in a loan agreement or a lease agreement with a lending institution with regard to an asset. The lending institution is a party having a security interest in the asset and/or a party interested in acquiring the security interest in the asset and/or a loan or a lease portfolio related to the asset. The system also includes a tracking server to receive the geospatial location data of the vehicle, determine a location of the vehicle and a pattern of usage thereof based on the received geospatial location data, and permit a financial entity server associated with the lending institution access to the location of the vehicle and the pattern of usage thereof.

Further, the tracking server is configured to determine an event based on the location of the vehicle and the pattern of usage thereof, and generate a risk score associated with the security interest in the asset and/or the loan or the lease portfolio related to the asset based on a risk scoring methodology implemented in a module stored in a memory thereof. The risk scoring methodology utilizes the event determination.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a vehicle configured to transmit a geospatial location data thereof, according to one or more embodiments.

FIG. 2 is a schematic view of a tracking server of FIG. 1.

FIG. 3 is a table illustrating the effect of a determined event related to the vehicle of FIG. 1 on the financial value of the vehicular security interest and a risk score associated therewith, according to one or more embodiments.

FIG. 4 is a schematic view of a data collection device of FIG. 1 configured to transmit data to a collection server, according to one or more embodiments.

FIG. 5 is process flow diagram detailing the operations involved in a vehicular geospatial location data based measurement of risk associated with a security interest in a loan/lease portfolio, according to one or more embodiments.

FIG. 6 is a process flow diagram detailing the operations involved in another vehicular geospatial location data based measurement of risk associated with a security interest in a loan/lease portfolio, according to one or more embodiments.

Other features of the present embodiments will be apparent from the accompanying drawings and from the detailed description that follows.

### DETAILED DESCRIPTION

Example embodiments, as described below, may be used to provide a method, a system and/or an apparatus of vehicular geospatial data based measurement of risk associated with a security interest in a loan/lease portfolio. Although the present embodiments have been described with reference to specific example embodiments, it will be evident that various modifications and changes may be made to these embodiments without departing from the broader spirit and scope of the various embodiments.

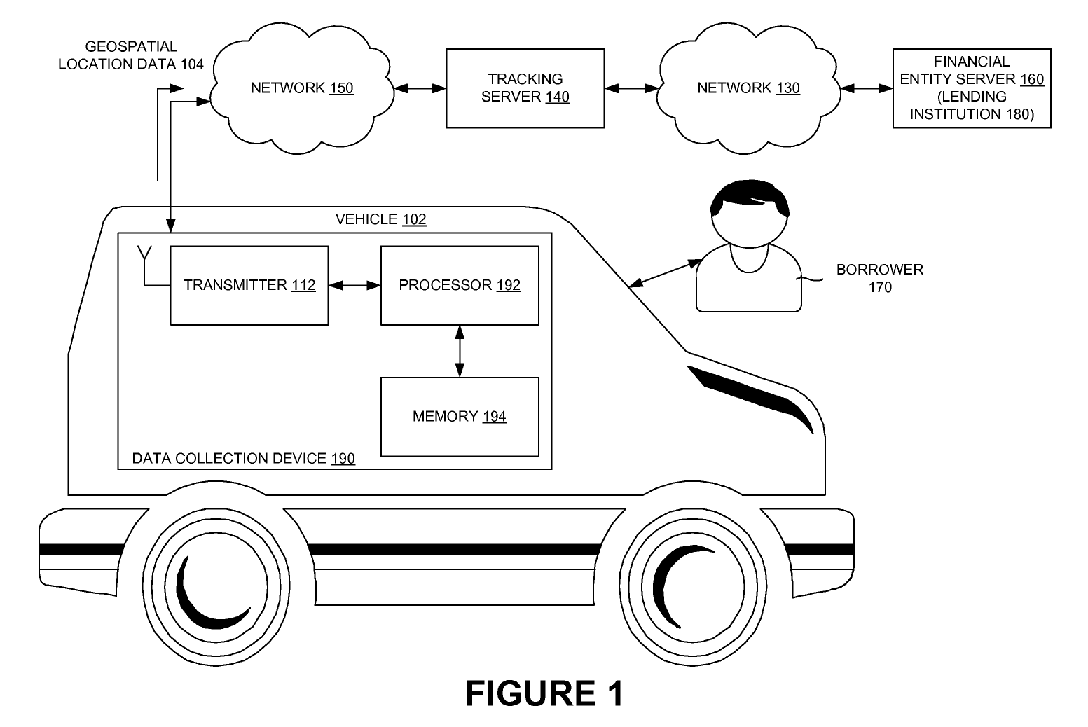

FIG. 1 shows a vehicle 102 configured to transmit a geospatial location data 104 thereof, according to one or more embodiments. In one or more embodiments, vehicle 102 may include a transmitter 112 (e.g., part of a transceiver) mounted therein to transmit geospatial location data 104 to a tracking server 140 (e.g., an entity providing tracking services, an Original Equipment Manufacturer (OEM)). In one or more embodiments, vehicle 102 may be obtained by a borrower 170 based on a loan/lease agreement between borrower 170 and a lending institution 180 (e.g., a bank, a credit union, an automobile dealer, a car rental agency). In one or more embodiments, lending institution 180 may be a party having a security interest in vehicle 102 and/or a party interested in acquiring the security interest in vehicle 102 and/or the loan/lease portfolio related to vehicle 102. In a preferred embodiment, tracking server 140 may be maintained by a third-party (e.g., provider of equipment including transmitter 112 and/or tracking services associated therewith) relative to lending institution 180.

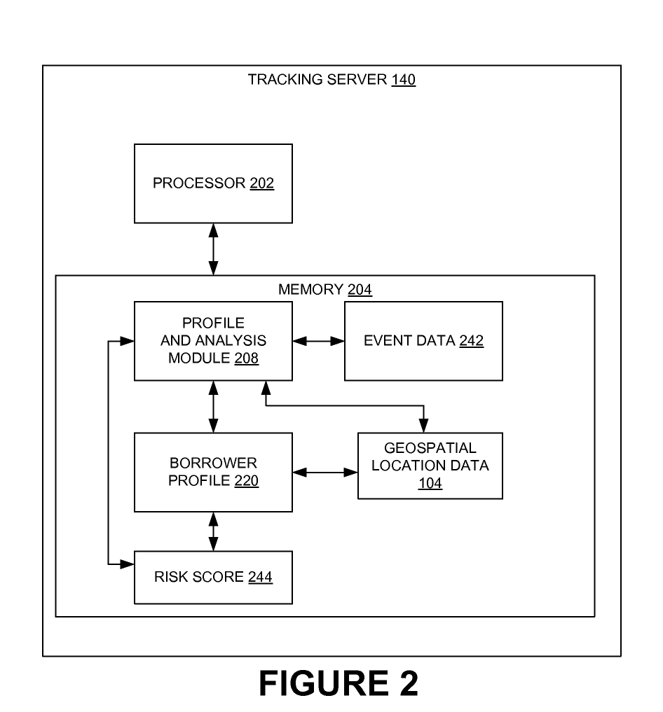

In one or more embodiments, lending institution 180 may be entitled to confiscate, seize and/or sell vehicle 102 to discharge the debt associated with a security interest in vehicle 102. In one or more embodiments, tracking server 140 may be configured to receive geospatial location data 104 of vehicle 102 at various points in time and store the aforementioned data in a memory thereof (see FIG. 2). For example, transmitter 112 mounted on vehicle 102 may transmit geospatial location data 104 thereof on a periodic basis (e.g., once every hour, once every day). In another example, transmitter 112 may transmit geospatial location data 104 of vehicle 102 whenever a condition (e.g., vehicle 102 transitioning into a new geographical location different from a default/current geographical location; geographical locations may be delimited by geospatial coordinates, vehicle 102 staying put at the same geographical location beyond a time period) is met.

In one or more embodiments, transmitter 112 may be part of a data collection device 190 installed on vehicle 102. In one or more embodiments, data collection device 190 may be a Global Position System (GPS) enabled device. GPS technology is well known to one of ordinary skill in the art and, therefore, discussion associated with acquiring location information, signal reception from orbiting satellites et al. is skipped for the sake of brevity and convenience. In one or more embodiments, data collection device 190 may include a processor 192 communicatively coupled to a memory 194. Here, processor 192 may be configured to address storage locations in memory 194 (e.g., a volatile memory), and may be configured to execute instructions (e.g., stored in memory 194) associated with the procuring of geospatial location data 104 and the transmission thereof, in conjunction with transmitter 112. Transmitter 112 is shown as being coupled to processor 192 in FIG. 1.

In one or more embodiments, data collection device 190 may be coupled to tracking server 140 through a network 150. In one or more embodiments, network 150 may be a mobile network or a Wide Area Network (WAN). FIG. 2 shows tracking server 140, according to one or more embodiments. In one or more embodiments, tracking server 140 may include a processor 202 communicatively coupled to a memory 204 (e.g., a volatile memory, non-volatile memory). Again, here, processor 202 may be configured to address storage locations in memory 204. In one or more embodiments, memory 204 may be configured to store geospatial location data 104 associated with vehicle 102. In one or more embodiments, memory 204 may also have a profiling and analysis module 208 stored therein. Profiling and analysis module 208 may include instructions executable through processor 202. The aforementioned instructions may be associated with processes such as analyzing geospatial location data 104 to profile borrower 170 and building a risk profile thereof.

Profiling and analysis module 208 may take into account events such as vehicle 102 being in the same geographical area (e.g., in an impound lot, out of state) for a long time. Profiling and analysis module 208 may also account for data collection device 190 being tampered with. For example, tampering of data collection device 190 by borrower 170 may trigger an appropriate message communication from data collection device 190 to tracking server 140. It is obvious that tracking server 140 may merely be a forwarding terminal, and that the aforementioned profiling and analysis may be performed on a master server distinct from the forwarding terminal. FIGS. 1-2 serve to present tracking server 140 as performing the profiling and analysis merely as an example. Alternatively, tracking server 140 may be a network of individual servers configured to perform one or more functions such as borrower profiling and/or analysis as a collective unit.

Several scenarios may serve to provide data for the profiling of borrower 170. For example, when vehicle 102 associated with borrower 170 does not appear at a specified location (e.g., work location) for a long time, tracking server 140 may profile borrower 170 based on the aforementioned risky behavior exhibited through the reception of geospatial location data 104 of vehicle 102. In another example, when vehicle 102 associated with borrower 170 leaves a geographical region representing a possible place of residence thereof and/or a possible place of work thereof for a long time (e.g., 15 days) and/or the new geographical location corresponding to geospatial location data 104 received at tracking server 140 is separated from the possible place of residence and/or the possible place of work by a long distance (e.g., 1000 miles), tracking server 140 may, again, profile borrower 170 as risky. In yet another example, vehicle 102 may be in an impound lot for a long time (e.g., 5 days), which may trigger tracking server 140 to profile borrower 170 appropriately. Other scenarios exhibiting eccentric usage pattern(s) of vehicle 102 are within the scope of the exemplary embodiments.

It is obvious that the collection of geospatial location data 104 of vehicle 102 on a regular basis may aid in better profiling of borrower 170 because borrower 170 may exhibit “patterns.” In one or more embodiments, tracking server 140 may generate borrower profile 220 of borrower 170 based on the pattern of behavior exhibited, and may transmit geospatial location data 104 and/or the aforementioned borrower profile 220 to a financial entity server 160 (or, any server associated with a party entitled to the access) directly associated with lending institution 180. Alternately, tracking server 140 may be interpreted as a network of servers including financial entity server 160. In one or more embodiments, borrower profile 220 may be updated with new geospatial location data 104 received from vehicle 102. In one or more embodiments, financial entity server 160 may be configured to generate one or more alerts regarding a need to confiscate vehicle 102 based on the received geospatial location data 104 and/or the risk pattern determined through tracking server 140. The profiling of borrower 170 may occur at tracking server 140 regardless of whether borrower 170 discharges duties associated with the loan/lease payments on a regular basis or not. The threshold tolerance limit of eccentricity in usage patterns of vehicle 102 may be higher for a borrower 170 diligently discharging loan/lease payment duties as compared to a borrower 170 defaulting on a regular basis.

Examples of events incorporated into analysis through profiling and analysis module 208 may include vehicle 102 venturing into a number of new geographical areas, vehicle 102 being in a new geographical area for a long time, borrower 170 defaulting on payments for a long time, borrower 170 violating terms of the loan agreement or the lease agreement with/without defaulting on payments, data collection device 190 being tampered with etc. Other derivable events are within the scope of the exemplary embodiments. In one or more embodiments, financial entity server 160 may be coupled to tracking server 140 through a network 130 (e.g., same as network 150, or, a different computer network).

In one or more embodiments, profiling and analysis module 208 may also provide for analyzing a pattern of usage of vehicle 102 based on data (including geospatial location data 104) received therefrom. The pattern of usage of vehicle 102 may be matched with event data 242 stored in memory 204 to assess a financial value of the security interest and/or the loan/lease portfolio associated with vehicle 102. Thus, a risk scoring methodology associated with the vehicular security interest and/or the loan/lease portfolio may be developed. Based on the aforementioned methodology, a risk score 244 associated with the vehicular security interest and/or the loan/lease portfolio may be generated; risk score 244 is shown as being stored in memory 204.

In one or more embodiments, the pattern of usage of vehicle 102 may be determined through profiling and analysis module 208 based on periodic analysis of geospatial location data 104 of vehicle 102. In one or more embodiments, the pattern of usage may be related to predetermined movement(s) of vehicle 102, some of which have been discussed above. In one example embodiment, the number of ignition starts and stops (e.g., borrower 170 may not have started vehicle 102 for a period of time, borrower 170 may have started vehicle 102 only once a week) and/or instances where vehicle 102 moves without being turned on (e.g., an indication that vehicle 102 is being towed) may also be determined through profiling and analysis module 208.

In one or more embodiments, profiling and analysis module 208 may apply an algorithm to determine the location of vehicle 102 and the pattern of usage thereof based on geospatial location data 104 and to compare the determined location of vehicle 102 and the pattern of usage thereof to one or more event data (e.g., event data 242). In one example embodiment, profiling and analysis module 208 may determine the location of vehicle 102 based on the pattern of usage thereof (e.g., pattern of usage may be determined based on geospatial location data 104). For example, vehicle 102 of borrower 170 may not have arrived at the place of residence of borrower 170 for two weeks. The amount of time and the distance traveled may be determined through profiling and analysis module 208, following which a risk scoring methodology may be applied. In an instance where vehicle 102 leaves a state of residence/work of borrower 170 for a longer time than usual, profiling and analysis module 208 may determine a higher risk score 244 and, hence, a lower financial value of the vehicular security interest.

In one or more embodiments, event data 242 may be associated with an event based on the location of the vehicle 102 and the pattern of usage thereof. Profiling and analysis module 208 may be capable of algorithmically determining multiple events to generate event data 242. Event data 242 may be associated with a predetermined combination of events including locations and times associated with borrower 170 and vehicle 102 thereof. For example, event data 242 may be associated with a location based predictive indicator of the financial value of the vehicular security interest and/or the vehicular loan/lease portfolio.

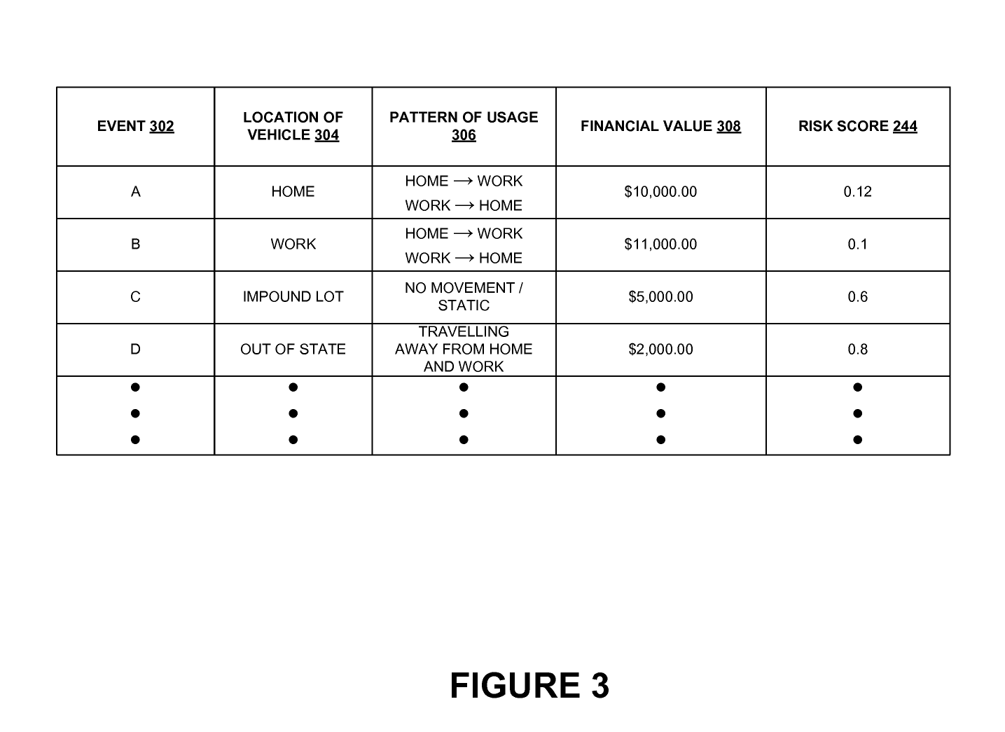

It is obvious that event data 242 may also be associated with an ignition start/stop with regard to vehicle 102, as discussed above. The aforementioned ignition event may also be incorporated in profiling of vehicle 102 (and borrower 170 thereof). FIG. 3 shows a table illustrating the effect of a determined event (e.g., event 302) on the financial value (e.g., financial value 308) of the vehicular security interest and risk score 244 associated therewith. As seen in FIG. 3, event (e.g., event 302) A may be associated with a pattern of driving (e.g., pattern of usage 306) from home to work and work to home, with vehicle 102 being parked at the home of borrower 170 (shown under location of vehicle 304). Event B may be associated with the same pattern of driving, except that vehicle 102 may be parked at the place of work of borrower 170. Event C may be associated with vehicle 102 being in an impound lot and Event D may be associated with vehicle 102 being driven out of state. FIG. 3 shows reduction in financial value 308 of the vehicular security interest and/or vehicular loan/lease portfolio when vehicle 102 is in the impound lot or when vehicle 102 is out of state. Risk score 244 is shown in FIG. 3 to correspondingly increase.

It is obvious that the risk scoring methodology may incorporate other data including but not limited to: account or identification number, state of loan/lease origination, date of contract, the original gross loan/lease balance, the original amount financed, the current gross loan/lease balance, the unearned finance charge, the current principal balance, the payment amount, the annual percentage rate of the loan, the original term of the loan/lease, the first payment date, the remaining term of the loan/lease, the number of payments made, the next due date, the year of vehicle 102 manufacture, the make of vehicle 102, the mileage on vehicle 102, the down payment made therefor and the credit bureau score of borrower 170. It can be appreciated that the risk scoring methodology may be implemented in profiling and analysis module 208 of several vehicles including vehicle 102 to determine the financial risk applicable to an entire vehicular loan/lease portfolio of an entity (e.g., an organization).

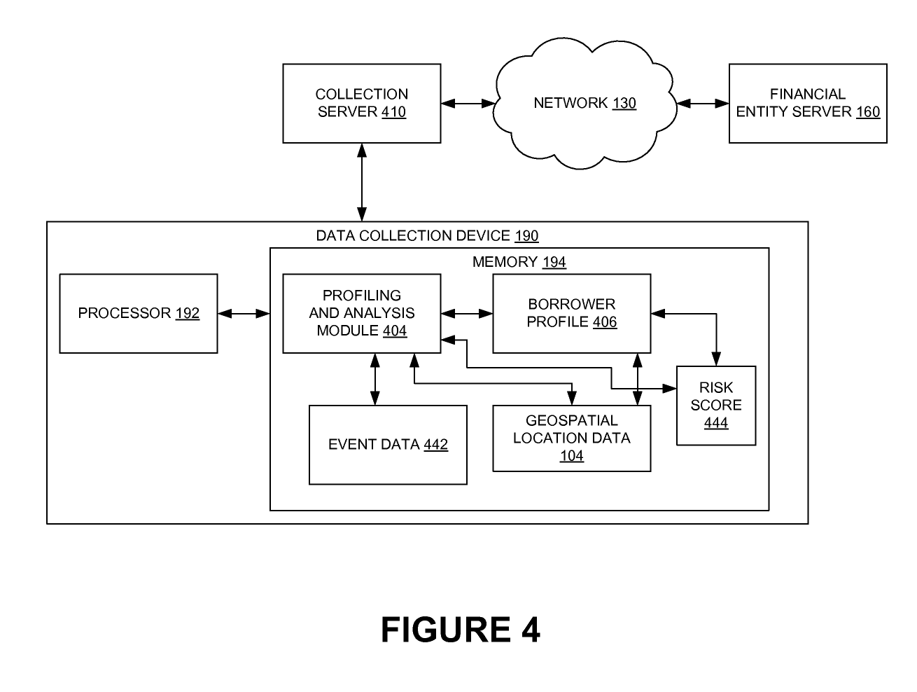

The risk scoring methodology may be made adaptable to accurately measure risk score 244 of the vehicular security interest and/or the vehicular loan/lease portfolio based on the location of vehicle 102 and the pattern of usage thereof. It may not always be required for geospatial location data 104 to be transmitted from vehicle 102 to tracking server 140. FIG. 4 shows data collection device 190 of vehicle 102 being configured to perform analysis of geospatial location data 104 thereat. Here, processor 192 may execute instructions associated with a profiling and analysis module 404 stored in memory 194. Profiling and analysis module 404 may perform the determination of risk score 244 analogous to tracking server 140 of FIGS. 1-2. Data (e.g., location of vehicle 102, usage pattern thereof and/or risk score 244) from data collection device 190 may then be transmitted to a collection server 410, which may then permit access to the location of vehicle 102, the pattern of usage thereof and/or risk score 444 (analogous to risk score 244; event data 442 may be analogous to event data 242; borrower profile 406 may be analogous to borrower profile 220) by lending institution 180 (e.g., through financial entity server 160 communicatively coupled to collection server 410 via computer network 130).

Although exemplary embodiments have been discussed with regard to a borrowed vehicle 102, concepts involved herein may also apply to a non-vehicular assets (e.g., a television, a house) financed by lending institution 180. The risk associated with non-vehicular loan/lease portfolios and non-vehicular security interests may also be determined analogous to the vehicular case.

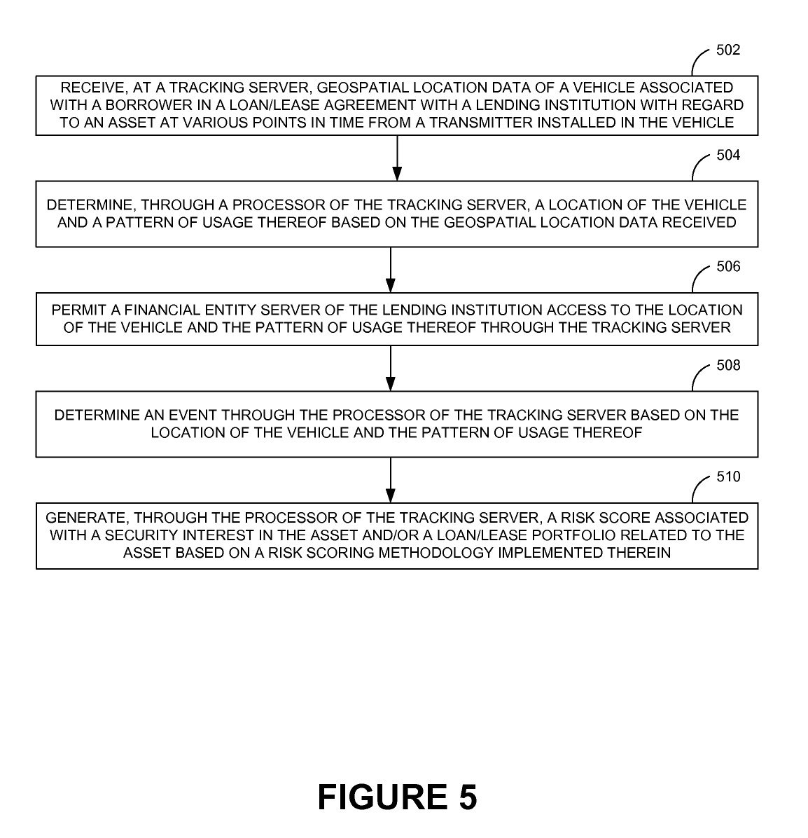

FIG. 5 shows a process flow diagram detailing the operations involved in a vehicular geospatial location data based measurement of risk associated with a security interest in a loan/lease portfolio, according to one or more embodiments. In one or more embodiments, operation 502 may involve receiving, at tracking server 140, geospatial location data 104 of vehicle 102 at various points in time from transmitter 112 installed in vehicle 102. In one or more embodiments, vehicle 102 may be associated with borrower 170 in a loan agreement or a lease agreement with lending institution 180 with regard to an asset. In one or more embodiments, lending institution 180 may be a party having a security interest in the asset and/or a party interested in acquiring the security interest in the asset and/or a loan or a lease portfolio related to the asset.

In one or more embodiments, operation 504 may involve determining, through processor 202 of tracking server 140, a location of vehicle 102 and a pattern of usage thereof based on geospatial location data 104 received. In one or more embodiments, operation 506 may involve permitting financial entity server 160 associated with lending institution 180 access to the location of vehicle 102 and the pattern of usage thereof through tracking server 140. In one or more embodiments, operation 508 may involve determining an event through processor 202 of tracking server 140 based on the location of vehicle 102 and the pattern of usage thereof.

In one or more embodiments, operation 510 may then involve generating, through processor 202 of tracking server 140, risk score 244 associated with the security interest in the asset and/or the loan or the lease portfolio related to the asset based on a risk scoring methodology implemented therein. In one or more embodiments, the risk scoring methodology may utilize the event determination.

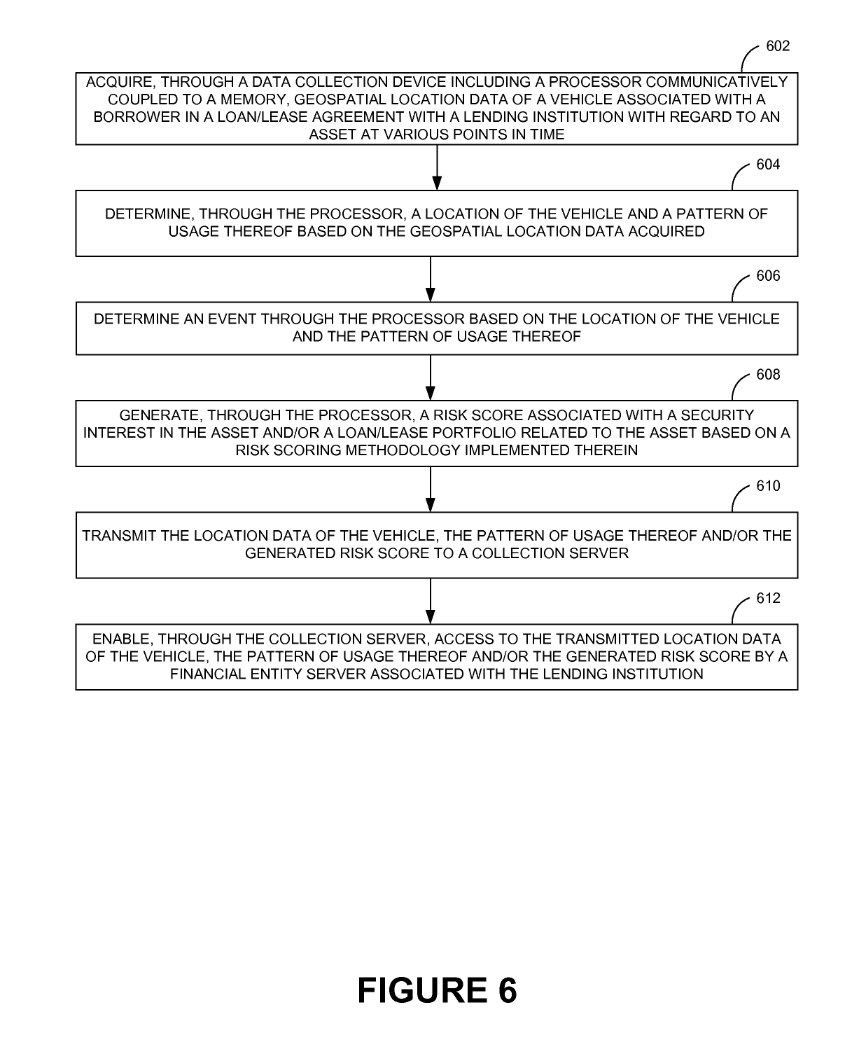

FIG. 6 shows a process flow diagram detailing the operations involved in another vehicular geospatial location data based measurement of risk associated with a security interest in a loan/lease portfolio, according to one or more embodiments. In one or more embodiments, operation 602 may involve acquiring, through data collection device 190 including processor 192 communicatively coupled to memory 194, geospatial location data 104 of vehicle 102 at various points in time. In one or more embodiments, vehicle 102 may be associated with borrower 170 in a loan agreement or a lease agreement with lending institution 180 with regard to an asset. In one or more embodiments, lending institution 180 may be a party having a security interest in the asset and/or a party interested in acquiring security interest in the asset and/or a loan or a lease portfolio related to the asset.

In one or more embodiments, operation 604 may involve determining, through processor 192, a location of vehicle 102 and a pattern of usage thereof based on geospatial location data 104 acquired. In one or more embodiments, operation 606 may involve determining an event through processor 192 based on the location of vehicle 102 and the pattern of usage thereof. In one or more embodiments, operation 608 may involve generating, through processor 192, risk score 244 associated with the security interest in the asset and/or the loan or the lease portfolio related to the asset based on a risk scoring methodology implemented therein. In one or more embodiments, the risk scoring methodology may utilize the event determination.

In one or more embodiments, operation 610 may involve transmitting the location data of vehicle 102, the pattern of usage thereof and/or the generated risk score 244 to collection server 410. In one or more embodiments, operation 612 may involve enabling, through collection server 410, access to the transmitted location data of vehicle 102, the pattern of usage thereof and/or the generated risk score 244 by financial entity server 160 associated with lending institution 180.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. A method comprising:
receiving, at a tracking server, geospatial location data of a vehicle at various points in time from a transmitter installed in the vehicle, the vehicle being associated with a borrower in one of a loan agreement and a lease agreement with a lending institution with regard to an asset, and the lending institution being at least one of a party having a security interest in the asset and a party interested in acquiring at least one of the security interest in the asset and one of a loan and a lease portfolio related to the asset;
determining, through a processor of the tracking server, a location of the vehicle and a pattern of usage thereof based on the geospatial location data received;
permitting a financial entity server associated with the lending institution access to the location of the vehicle and the pattern of usage thereof through the tracking server;
determining an event through the processor of the tracking server based on the location of the vehicle and the pattern of usage thereof; and
generating, through the processor of the tracking server, a risk score associated with the at least one of the security interest in the asset and the one of the loan and the lease portfolio related to the asset based on a risk scoring methodology implemented therein, the risk scoring methodology utilizing the event determination.

2. The method of claim 1, further comprising utilizing, through the processor of the tracking server, the risk score to indicate a financial value of the security interest in the asset.

3. The method of claim 1, further comprising receiving, through the tracking server, an alert relating to confiscating the vehicle based on the access of the location thereof by the financial entity server.

4. The method of claim 1, wherein the tracking server and the lending institution are configured to communicate through a computer network.

5. The method of claim 1, wherein the risk score generation at the tracking server incorporates tampering with a data collection device including the transmitter installed in the vehicle.

6. The method of claim 1, wherein the event determined through the processor is related to a use of an ignition of the vehicle.

7. The method of claim 1, wherein at least one of the determination of the location of the vehicle and the pattern of usage thereof and the risk score determination further comprises forwarding the geospatial location data of the vehicle to another server for analysis thereat.

8. The method of claim 1, comprising receiving the geospatial location data of the vehicle at the tracking server on a periodic basis.

9. A method comprising:
acquiring, through a data collection device including a processor communicatively coupled to a memory, geospatial location data of a vehicle at various points in time, the vehicle being associated with a borrower in one of a loan agreement and a lease agreement with a lending institution with regard to an asset, and the lending institution being at least one of a party having a security interest in the asset and a party interested in acquiring at least one of the security interest in the asset and one of a loan and a lease portfolio related to the asset;
determining, through the processor, a location of the vehicle and a pattern of usage thereof based on the geospatial location data acquired;
determining an event through the processor based on the location of the vehicle and the pattern of usage thereof;
generating, through the processor, a risk score associated with the at least one of the security interest in the asset and the one of the loan and the lease portfolio related to the asset based on a risk scoring methodology implemented therein, the risk scoring methodology utilizing the event determination;
transmitting at least one of the location data of the vehicle, the pattern of usage thereof and the generated risk score to a collection server; and
enabling, through the collection server, access to the at least one of the transmitted location data of the vehicle, the pattern of usage thereof and the generated risk score by a financial entity server associated with the lending institution.

10. The method of claim 9, further comprising utilizing, through the processor of the data collection device, the risk score to indicate a financial value of the security interest of the asset.

11. The method of claim 9, further comprising receiving, through the collection server, an alert relating to confiscating the vehicle based on the access of the location data thereof by the financial entity server.

12. The method of claim 9, wherein the collection server and the financial entity server are configured to communicate through a computer network.

13. The method of claim 9, wherein the risk score generation at the data collection device incorporates tampering with the data collection device.

14. The method of claim 9, wherein the event determined through the processor of the data collection device is related to a use of an ignition of the vehicle.

15. A system comprising:
a vehicle including a transmitter installed therein to transmit geospatial location thereof at various points in time, the vehicle being associated with a borrower in one of a loan agreement and a lease agreement with a lending institution with regard to an asset, and the lending institution being at least one of a party having a security interest in the asset and a party interested in acquiring at least one of the security interest in the asset and one of a loan and a lease portfolio related to the asset; and
a tracking server to:
receive the geospatial location data of the vehicle,
determine a location of the vehicle and a pattern of usage thereof based on the received geospatial location data,
permit a financial entity server associated with the lending institution access to the location of the vehicle and the pattern of usage thereof,
determine an event based on the location of the vehicle and the pattern of usage thereof, and
generate a risk score associated with the at least one of the security interest in the asset and the one of the loan and the lease portfolio related to the asset based on a risk scoring methodology implemented in a module stored in a memory thereof, the risk scoring methodology utilizing the event determination.

16. The system of claim 15, wherein the tracking server is configured to utilize the risk score to indicate a financial value of the security interest in the asset.

17. The system of claim 15, wherein the tracking server is further configured to receive an alert relating to confiscating the vehicle based on the access of the location thereof by the financial entity server.

18. The system of claim 15, wherein the tracking server and the financial entity server are communicatively coupled through a computer network.

19. The system of claim 15, wherein the tracking server incorporates tampering with a data collection device including the transmitter installed in the vehicle by the borrower in the risk score generation therethrough.

20. The system of claim 15, wherein the tracking server is further configured to forward the geospatial location data of the vehicle to another server in order to perform analysis associated with at least one of the determination of the location of the vehicle and the pattern of usage thereof and the risk score determination therethrough.
